(19) United States
(12) Patent Application Publication
(10) Pub. No.: US 2011/0068948 A1
(43) Pub. Date: Mar. 24, 2011

(54) In-vehicle Christmas tree for drag racing starting and timing

(76) Inventor: Martin Ashley Edmunds, Milton, WV (US)

(21) Appl. No.: 12/586,239

(22) Filed: Sep. 19, 2009

(51) Int. Cl. G08G 1/00

(52) U.S. Cl. 340/901

(57) ABSTRACT

In accordance with one embodiment an in-vehicle Christmas tree for drag racing starting and timing where a prior art drag tree is not available or convenient. An accelerometer integrated circuit provides means to synchronize all tree devices in a race and to detect a change in motion and/or acceleration instead of mounted stationary switches for pre-stage and stage positions of the prior art. This enables drivers the option of starting a drag race from a rolling start and/or to have predetermined distances offsetting a vehicle's starting position in relation to the other participating vehicle or vehicles, while simultaneously providing false start detection. The present invention comprising a tree device (10) attached to a vehicle's windshield by windshield mount assembly (8) and fastener (9). A control unit (17) is supplied with power from the vehicle through power cable (19) or by a replaceable internal battery (44). The tree device is controlled by the driver with remote unit (12) by pressing set button (15) to either initiate a race or respond to a race initiated by a competitor through a wireless communication transceiver on control unit circuit board (18). The control unit provides a means for wireless communication allowing to race more than two vehicles at a time.

### CROSS-REFERENCE TO RELATED APPLICATIONS

None

### FEDERALLY SPONSORED RESEARCH

None

### SEQUENCE LISTING

None

### FIELD OF THE INVENTION

The present invention relates to a drag racing starting and timing system, and more particularly, for an in-vehicle drag racing starting and timing system that allows drag racing when a prior art drag tree is not available and enables starting and timing for different styles of drag racing.

### DESCRIPTION OF PRIOR ART

Prior art drag tree is referred to as a Christmas tree drag race starter and timer device for the starting of two race vehicles. The Christmas tree drag race starter and timer device is referred to as simply a drag tree. A drag tree is a stationary mounted identical double row of vertical lights, one row for each lane/driver and is placed on the track positioned between and in front of the two racing vehicles. The drag tree in FIG. 1 includes pre-stage lights 1, stage lights 2, sequencing lights 3, start light 4, and foul light 5.

The pre-stage and stage lights are indicators for the drivers to know when they are positioned correctly. Pre-stage switch 7 is the trigger for illuminating the pre-stage lights while stage switch 6 is the trigger for illuminating the stage lights and starting a countdown sequence. Each lane has it's own set of pre-stage and stage switches.

Official drag racing rules state that both vehicles must be in the pre-stage position before either vehicle can advance forward to the stage position. The prior art drag tree method of initiating a race is when both vehicles are triggering the precisely positioned stationary external stage switches. This triggers the drag tree's control unit to start the countdown sequence. The sequence lights illuminate on and off one at a time traveling down the tree at a predetermined rate. Once the sequence lights have sequenced through, the start light illuminates telling the drivers to go. If either vehicle leaves the stage position before the start light illuminates, the corresponding lane's foul light illuminates indicating a false start resulting in a win for the vehicle in the other lane.

Several timing issues arise when trying to drag race at a site that is not equipped with a drag tree, such as start timing and/or detecting if a false start condition has occurred. Sometimes a tree device called a portable drag tree may be used.

A portable drag tree is a prior art drag tree that stands on the track between the two racing vehicles but is not permanently mounted. A portable drag tree is also not permanently wired to the race track's power grid and is designed to be transported to different drag racing sites. However, the prior art portable drag tree does not incorporate an internal power source such as a battery therefore, the drivers' choice of race sites become limited to sites containing a suitable power supply. In addition, the prior art drag tree is designed to be placed on the track during operation and cannot be operated inside a race vehicle.

Another problem with the prior art drag tree is a driver can see both lanes' drag tree lights. This can result in a false start. This condition occurs because both sides of the drag tree are visually accessible to each driver simultaneously allowing a driver in one lane to accidentally concentrate and focus on the other driver's lights. In the Professional/non-handicap racing category this is not an issue because both vehicles start at the same time thus both sets of lights on the drag tree sequence together. The problem presents itself in the Sportsman/handicap category where each side of the tree starts sequencing at different times. In this situation the drag tree countdown sequence in the faster vehicle's lane is staggered or delayed by the drag tree's control unit to allow the slower vehicle to leave sooner.

In this category the drag tree's sequence lights are timed to start in such a way if both vehicles start exactly when their corresponding start light illuminates, the resulting race outcome should be a tie between the vehicles. Therefore, when the driver of the faster vehicle observes the slower vehicle's drag tree lights sequencing, the mistake of starting off of the other lane's start light may occur. This results in a false start against the faster vehicle and an automatic win for the slower vehicle.

Another problem with the prior art drag tree arises in that no provisions are provided for offsetting a vehicle's starting position in relation to the competitor's vehicle. A prior art drag tree's control unit calculations of starting and timing and false start conditions are based completely from the stage switch's precise stationary location. In unsanctioned drag races some drivers prefer an offset start method. In an offset start method of drag racing, the slower vehicle is started at a predetermined distance ahead of the faster car. This method allows the drivers to visualize how vehicles perform against each another and also increases the slower vehicle's chances of winning the race.

Another problem of the prior art drag tree is vehicles are limited to starting from a stationary condition. Due to track condition or other factors such as vehicle horsepower, a vehicle's ability to get traction becomes an issue causing the vehicle to not run consistent. In unsanctioned drag races, the drivers may desire to start the race while the racing vehicles are rolling at a predetermined speed instead of starting from a fixed stationary position. The prior art drag tree has no timing and starting provisions for allowing a rolling start and/or detecting a false start during this type of start condition.

Yet another problem of the prior art drag tree presents itself when more than two drivers want to drag race at a time. Prior art drag tree devices provide starting and timing and false start detection for up to two vehicles to drag race at a time.

### SUMMARY OF PRESENT INVENTION

In accordance with one embodiment the present invention has for a general object the provision of a Christmas tree for drag racing starting and timing and more specifically, for an in-vehicle drag racing starting and timing system that is installed and utilized in or on the race vehicle comprises a tree device, control unit, and remote unit, allowing the possibility of drag racing where no prior art tree device is available or convenient.

It is another purpose and/or objective to provide a system and method of starting and timing for drag racing for which the control unit can be powered by a plurality of power sources. Power can be supplied from the race vehicle or from an internal replaceable battery. This allows the possibility of drag racing vehicles where no external power sources are available for prior art tree devices.

It is yet another purpose and/or objective to provide a system and method of starting and timing for drag racing utilizing rolling starts. This method of racing may be preferred when race surface conditions do not allow vehicles optimum traction when starting from a stationary condition. During this type of drag race, vehicles are allowed to roll steadily at a predetermined speed while the tree device counts down without creating a false start. Unlike prior art tree devices, the present invention is able to detect a false start if one or more vehicles exhibit a change in motion and/or acceleration before the start light is illuminated.

It is yet another purpose and/or objective to provide a system and method of starting and timing for drag racing a means allowing offsetting vehicle start position in relation to other participating vehicles at the start of a drag race. This method may be used when one or more vehicles are considerably faster than other vehicles in the race. In this situation, the slower vehicle would be granted a predetermined distance ahead of the faster vehicle. The present invention does not base timing and starting and/or false start detection based on a stationary switch and/or vehicle position.

It is yet another purpose and/or objective to provide a system and method of starting and timing for drag racing incorporating a means to eliminate the possibility of false starts due to both drivers having visual access to both sides of the drag tree simultaneously. The present invention is equipped with only one set of sequence LED's and one start LED that relates only to the vehicle it is mounted in.

It is yet another purpose and/or objective to provide a system and method of starting and timing for drag racing using a means of wireless radio communication between tree devices' control units. This allows more than two vehicles to race at a time. The present invention's number of vehicles allowed to enter a race is limited only by the control unit's radio frequency signal range.

It is yet another purpose and/or objective to provide a system and method of starting and timing for drag racing having a means of direct communication between drivers using a combination means of wireless communication and a set of indicator LED's to signal when said drivers are set to race. In prior art tree devices, each driver has visual access to each other's pre-stage and stage tree lights and therefore can determine if the other driver is ready to race by line of sight vision. In the present invention the driver only sees his/her corresponding tree device lights therefore having to rely on means of wireless communication between control units.

### BRIEF DESCRIPTION OF THE DRAWINGS

FIG. 1 is a perspective view of a prior art drag tree comprising of pre-stage lights 1, stage lights 2, sequence lights 3, start light 4, and foul light 5. The tree is constructed in such a way that the left side of the tree is mirrored by the right side providing each lane/driver a corresponding set of lights. Pre-stage lights are triggered by optic switch 7. Stage lights and tree count down sequence are triggered by optic switch 6.

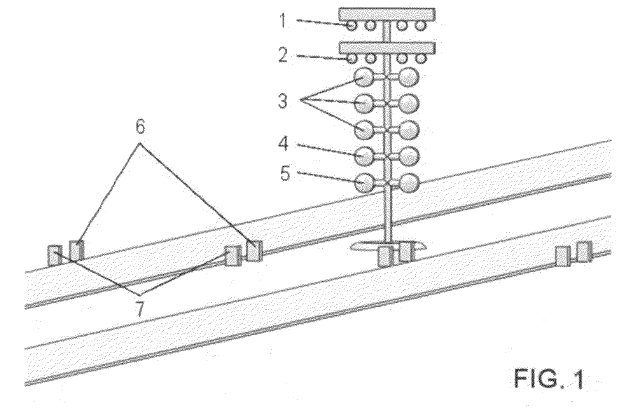

FIG. 2 is a perspective view constructed in accordance with the invention. Windshield mounting assembly 8 is connected to tree device 10 by fastener 9. Tree device is controlled by control unit 17. Communication cable 11 connects the tree device to control unit circuit board 18. Remote unit 12 comprises of set button 15 and reset button 14. Remote cable 16 connects the control unit circuit board to remote unit circuit board 13. One means of power is supplied by the race vehicle through power cable 19.

FIG. 3 is a front view of tree device 10 comprising of identification transmit LED's 27 placed in the upper left and across from identification receive LED's 20. Directly underneath are driver set LED's 26 and competitor set LED's 21. Located central and down the middle of the tree housing are sequence LED's 22 and start LED 23. Driver false start LED's 25 and competitor false start LED's 24 are located at the lower end of the tree device.

FIG. 4 is a perspective view of the control unit circuit board. Control unit circuit board main components comprise of microcontroller 29, accelerometer integrated circuit 28, and radio frequency transceiver 30.

FIG. 5 is an internal view of communication cable 11 comprising of tree device LED control wires 32, and radio frequency antenna cable 33.

FIG. 6 is a perspective rear internal view of tree device 10 illustrating radio frequency antenna cable 33 and radio frequency antenna 34.

FIG. 7 is a perspective view of the windshield mounting assembly comprising of suction cup 36, windshield slope adjusting hinge 37, support shaft 38, viewing angle ball and socket adjustment 39, and tree device mount 40.

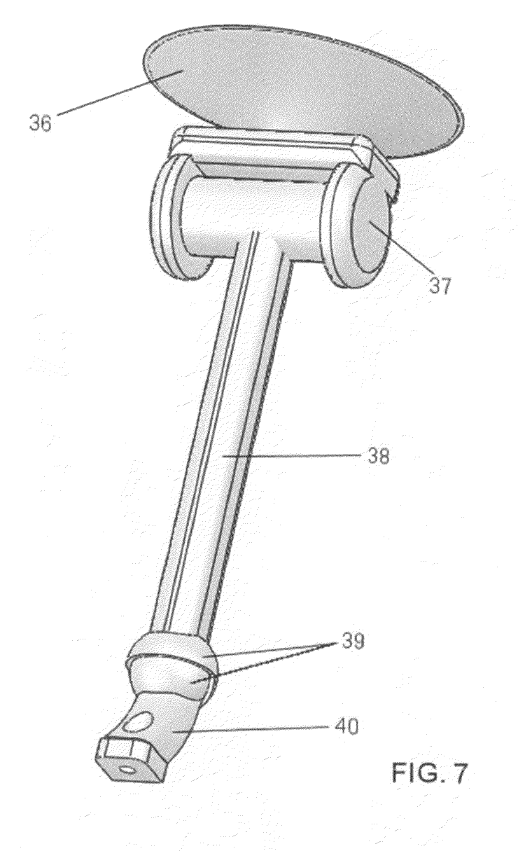

FIG. 8 is perspective rear view of control unit 17 illustrating primary means of vehicle power supply 19, secondary power supply means replaceable battery 44, battery terminals 43, battery compartment 41, and battery cover door 42.

FIG. 9 is a block diagram illustrating a flowchart of the method in the most general form. The flowchart comprises stages (a) IDR/IDT cycle, (b) Competitor Initiated Race, (c) Driver Initiated Race, (d) Synchronize Countdown, and (e) False Start Memory.

FIG. 10 is a detailed block diagram illustrating a flowchart of method FIG. 9, stage (a).

FIG. 11 is a detailed block diagram illustrating a flowchart of method FIG. 9, stage (b).

FIG. 12 is a detailed block diagram illustrating a flowchart of method FIG. 9, stage (c).

FIG. 13 is a detailed block diagram illustrating a flowchart of method FIG. 9, stage (d).

FIG. 14 is a detailed block diagram illustrating a flowchart of method FIG. 9, stage (e).

FIG. 15 is a schematic diagram of the control unit illustrating microcontroller 29, accelerometer integrated circuit 28, radio frequency transceiver 30.

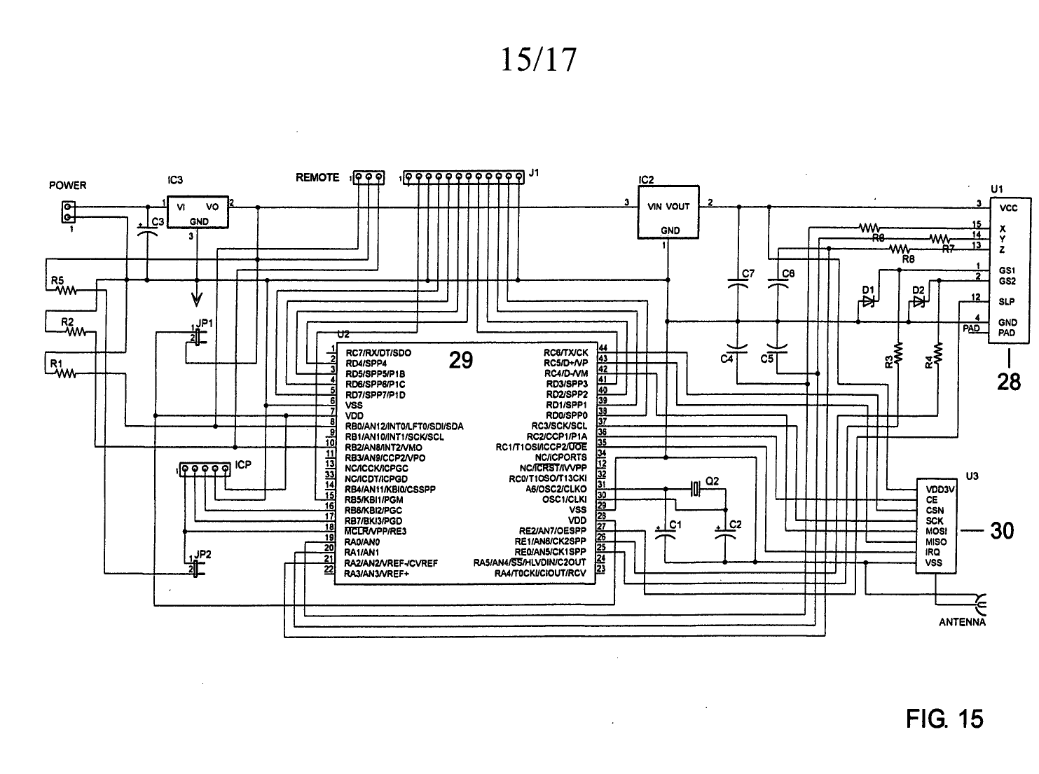

FIG. 16 is a schematic diagram of the tree device illustrating identification transmit LED's 27, identification receive LED's 20, driver set LED's 26, competitor set LED's 21, driver false start LED 25, competitor false start LED 24, sequence LED's 22, and start LED 23.

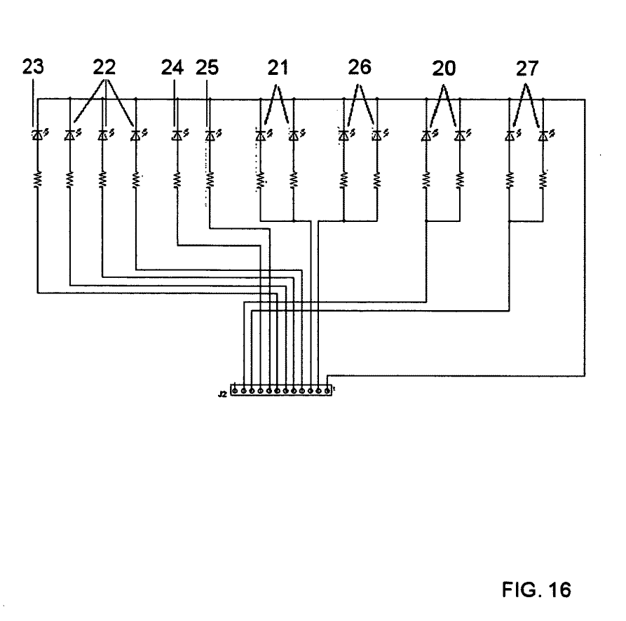

FIG. 17 is a schematic diagram of the remote unit illustrating set button 15 and reset button 14.

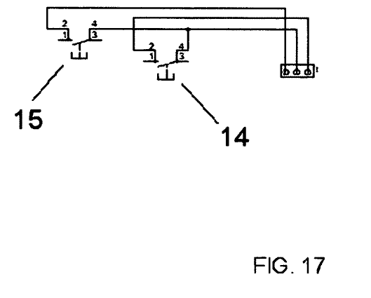

### DETAILED DESCRIPTION

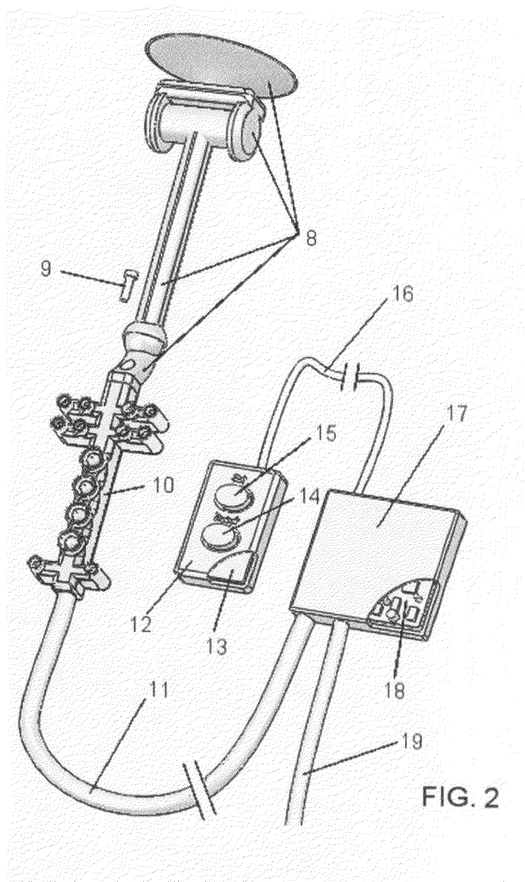

Referring to FIG. 2, each racing vehicle has a tree device installed inside the driver compartment on the vehicle windshield or any other place that is visually convenient using windshield mounting assembly 8. Control unit 17 is generally mounted firmly on a structural surface such as behind vehicle dashboard or under center console. Inside the control unit is control unit circuit board 18. Remote unit 12 is mounted within drivers reach, generally on center console or where the driver can easily access set button 15 and reset button 14.

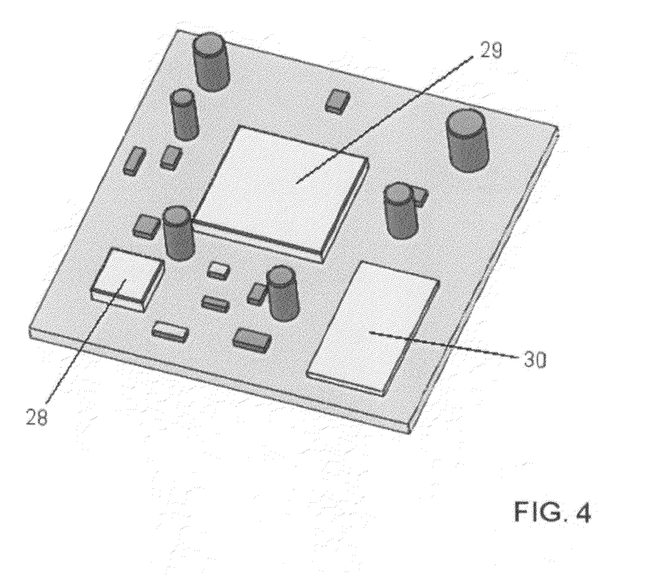

Referring to FIG. 4, the control unit circuit board comprises of microcontroller 29, accelerometer integrated circuit 28, and radio frequency transceiver 30. The accelerometer integrated circuit will be referred to as simply “accelerometer.” The radio frequency transceiver will be referred to as “RF transceiver.”

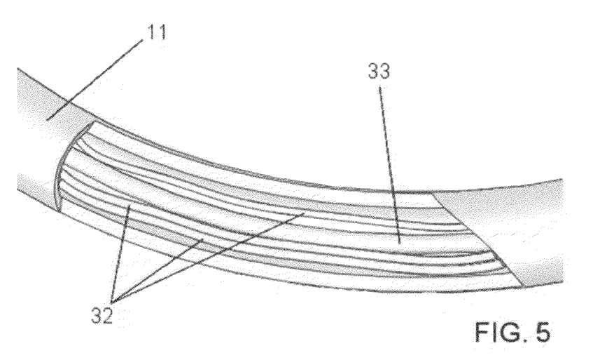

Referring to FIG. 5, communication cable 11 connects the tree device to the control unit. The communication cable houses RF transceiver antenna cable 33 and LED control wires 32.

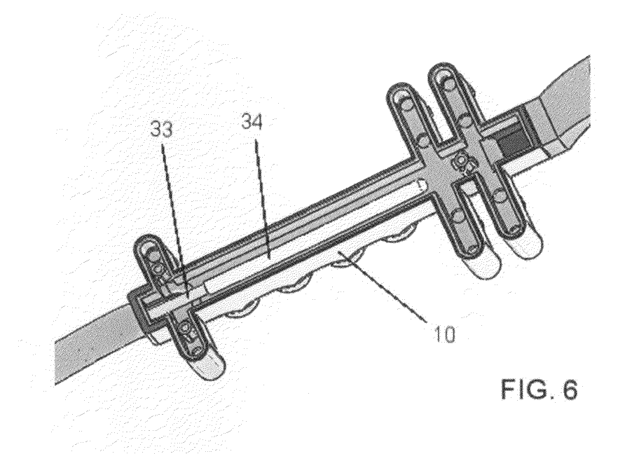

Referring to FIG. 6, RF transceiver antenna cable 33 connects to RF transceiver antenna 34. The RE transceiver antenna is mounted vertically inside tree device 10.

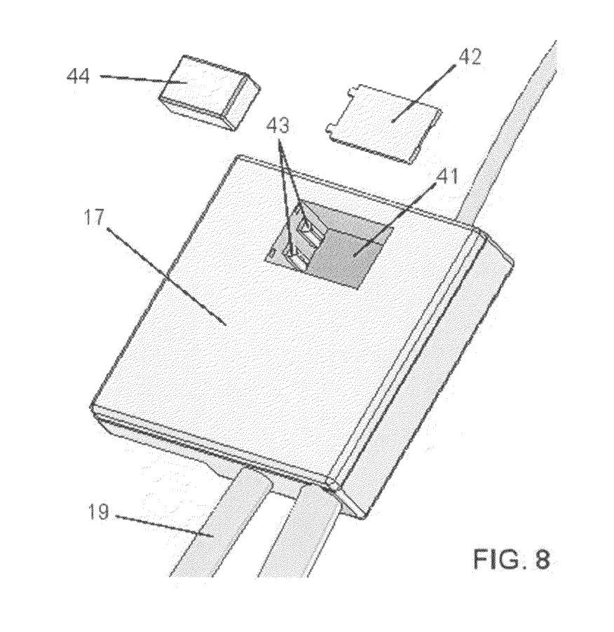

Referring to FIG. 8, Power can be supplied to control unit by the race vehicle through power cable 19. More conveniently, power can be supplied by a replaceable battery 44, connected to battery connector 43. Battery is secured in battery compartment 41 with battery cover 42.

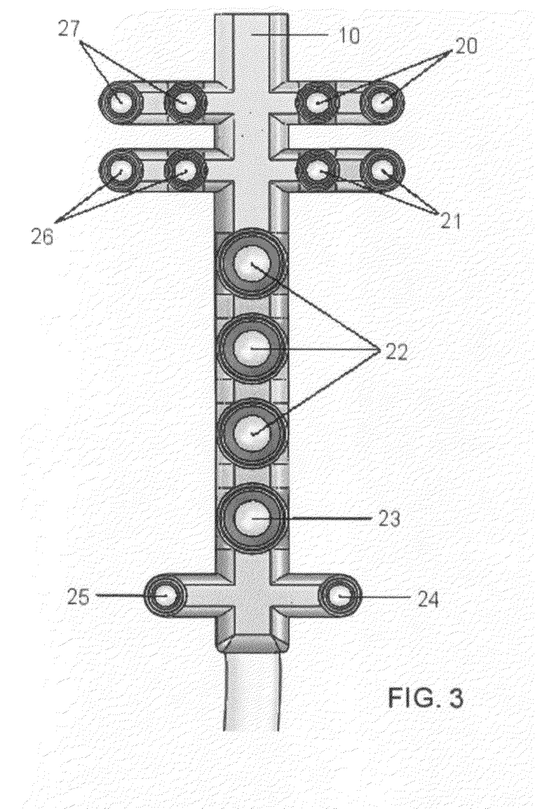

Referring to FIG. 3, when powered on, the control unit's RF transceiver enters into receive mode. If the driver does not press the Set button on the remote unit, the RF transceiver is instructed by the microcontroller to start cycling between receive mode and transmit mode. While in transmit mode, the Tree Identification Transmit (IDT) LED's 27 illuminate indicating an identification signal is transmitting. Any tree device control units that are within receiving range will receive this IDT signal. Tree Identification Receive (IDR) LED's 20 on all competitor tree devices are illuminated at this time notifying them other trees are in range. This cycling will be referred to as the “IDR/IDT cycle.”

When a race is to be initiated by a driver, the set button is pressed on the remote unit which disables the control unit's IDR/IDT cycle, calibrates the accelerometer's output, enables the microcontroller to detect a false start condition, and lights driver set LED's 26. The first tree device to have the set button pressed becomes the master which is now referred to as “master tree device” or “master control unit.”

A driver set signal is then transmitted from the control unit of the master tree device to all nearby tree devices' control units. When competitors' control units receive the driver set signal, the competitor set LED 21 illuminates on their tree devices. The master control unit now pauses for a predetermined time to allow an initial competitor to respond. A competitor responds by pressing his/her set button which in turn disables his/her control unit's IDR/IDT cycle, the accelerometer's output is calibrated, enables the microcontroller to detect a false start condition, illuminates the driver set LED's, and transmits a driver set signal. The competitor's control unit is now prepared to receive the synchronize countdown signal from the master control unit.

When the master control unit receives the driver set signal the control unit illuminates the tree device competitor set LED's. If said driver set signal is not received after a predetermined delay, the master control unit will reset back to the IDR/IDT cycle.

Once the master control unit illuminates the competitor set LED's, a predetermined delay occurs to allow more vehicles to enter the race. The master control unit ignores all other received driver set signals after the first competitor responds. The first competitor to respond is referred to as the “primary competitor.” The signals sent from later entering competitors will be referred to as “secondary competitors.” All secondary competitors' control units are now listening for the same synchronize countdown signal as the primary competitor. The master control unit transmit's the synchronize countdown signal. It is at this time all participating tree devices start counting down together with the master tree device. During this count down, sequence LED's 22 are illuminated on and off one at a time for 0.5 seconds each until all sequence LED's have been cycled. When the last sequence LED has been turned off, 0.5 seconds later start LED 23 is illuminated telling drivers to go.

While participating tree devices are counting down, their control units' RF transceivers are listening for a false start signal. Also, the microcontroller in each control unit monitors the accelerometer output during the sequence count down. If the accelerometer indicates a change in motion and/or acceleration, the faulting vehicle's control unit illuminates driver false start LED 25. The corresponding vehicle's RF transceiver switches to transmit mode briefly and transmit's a start fault signal to the other participating control units. All said participating tree devices illuminate their competitor false start LED 24 indicating one of the other racing vehicles false started.

Unlike false starts in prior art tree devices that are related to vehicle positioning only, the present invention incorporates an accelerometer integrated circuit to determine if a change in vehicle motion and/or acceleration has occurred. This allows the option of starting from a roll and/or starting from different locations in relation to each vehicle.

If a false start has occurred, the false start LED remains on until the reset button on the remote unit is pushed. This method serves as a memory for false starts on the last race run. Each tree device false start indicator is able to be cleared or reset locally by the driver of that particular vehicle. In other words, if a driver creates a false start and then presses the reset button on his/her remote unit to clear the false start indication, the false start LED will only be cleared on that particular tree device. The false start indicators remain intact on all other participating tree devices until each are reset by the respectful driver. The driver has the option to press the remote unit's reset button at any time. This resets the tree to it's initial power on receive state regardless of tree device status.

A method for vehicle timing and test or VTT cycle is started by pressing the set button for three seconds. A driver, new to the tree device, can execute practice runs to experiment with the synchronize LED's, start LED and driver false start timing without initiating a race with a competitor. When using this method, the RF transceiver stays in receive mode only.

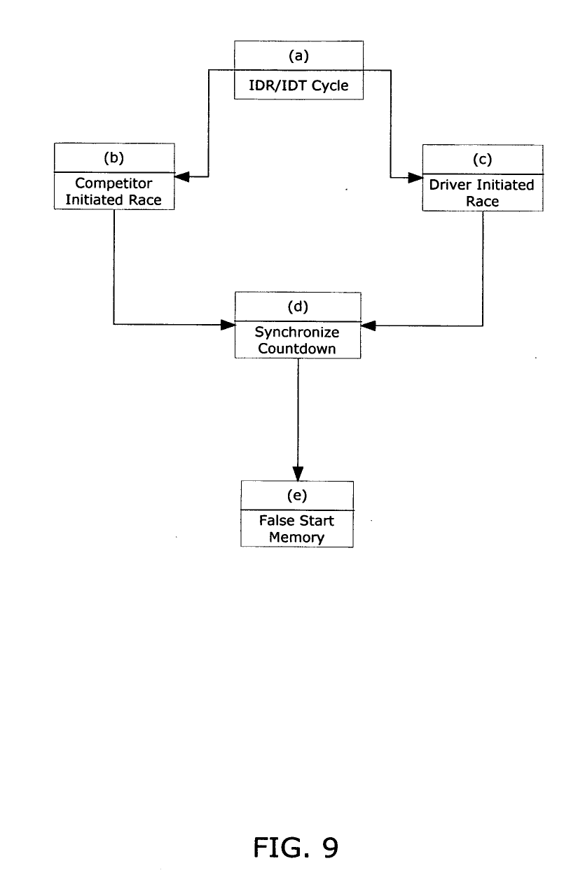

FIG. 9 is a block diagram illustrating a flowchart of the method in the most general form carried out by the microcontroller. Stage (a) represents the IDR/IDT cycle. It is this stage in which the control unit receives another control unit's transmitted ID signal. It is determined in stage (a) if method path stage (b) or method path (c) will be executed next.

Stage (b) is the Competitor Initiated Race method.

Stage (c) is the Driver Initiated Race method. It is from stage (c) in which the VTT cycle method is accessed.

Stage (d) is the Synchronize Countdown method from which the synchronize countdown timing occurs. This method is common to stage (b) and stage (c).

Stage (e) is the method of false start memory and reset.

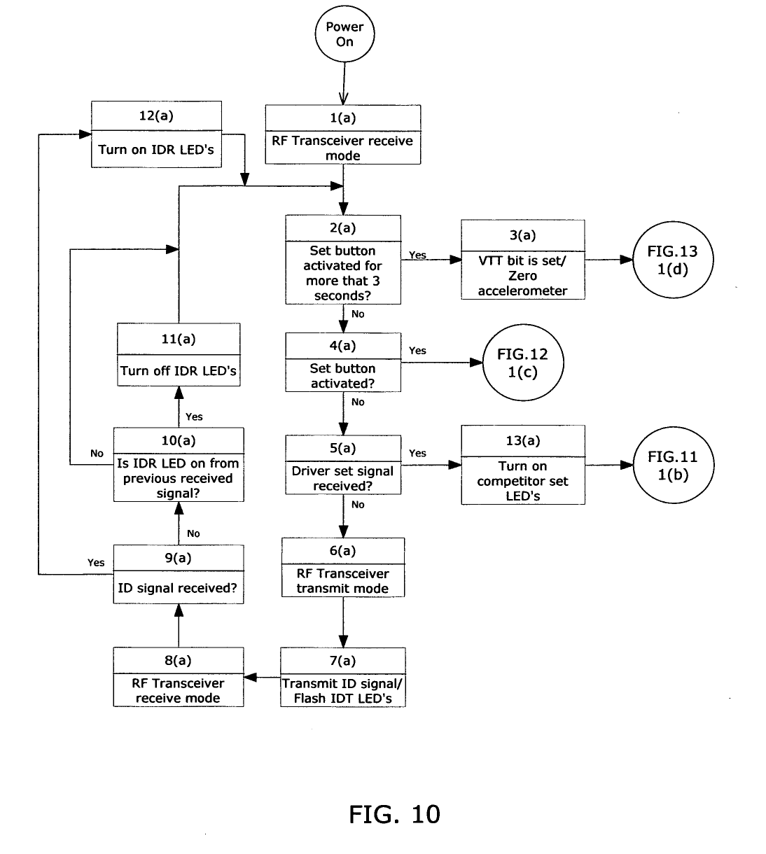

FIGS. 10, 11, 12, 13, and 14 are further detailed block diagrams illustrating flowcharts of methods contained in each stage of FIG. 9. Each stage is divided and illustrated into more detailed method blocks.

Stage (a) IDR/IDT Cycle

FIG. 10 is a detailed block diagram illustrating a detailed flowchart of FIG. 9 stage (a), IDR/IDT. Referring to FIG. 10, block 1(a) RF transceiver is switched to receive mode enabling the detection of any nearby control units' ID signal.

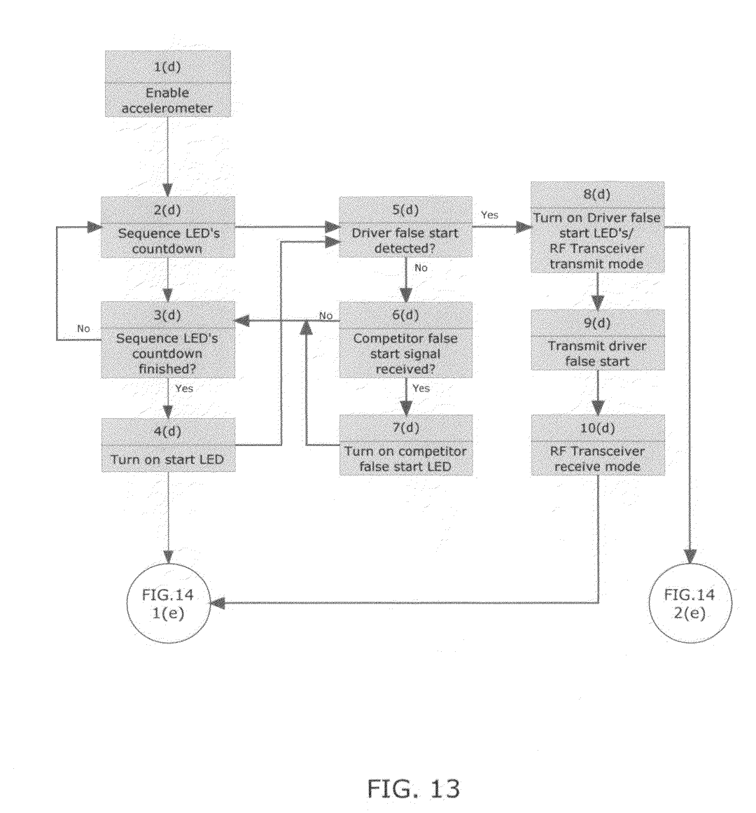

In block 2(a) the set button is examined to determine if it is activated for longer than three seconds. If the set button is activated for three seconds or longer, the method path of FIG. 13, block 1(d) is executed of which will be covered later in detail.

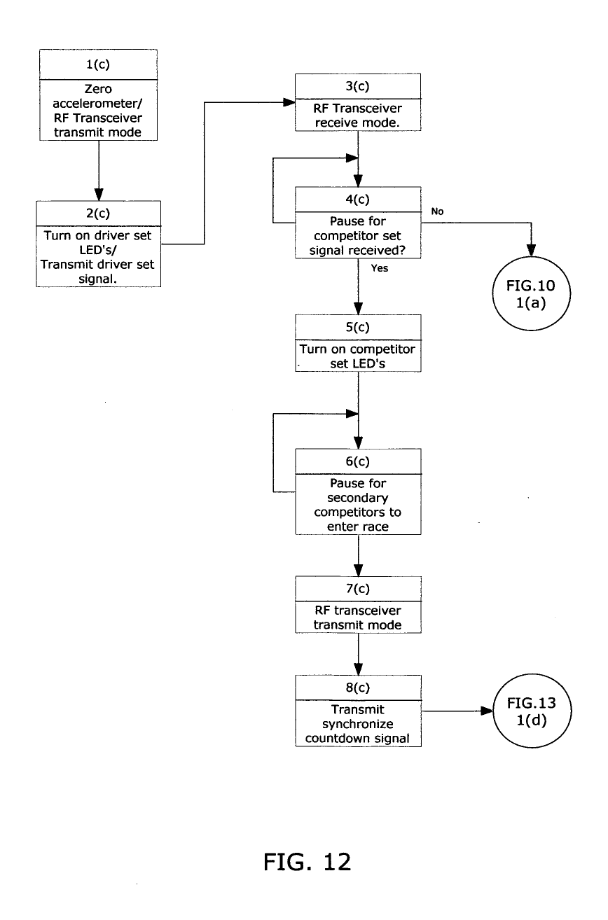

If said set button is activated for less than three seconds, block 4(a) executes next, determining if the set button was ever activated. If said set button is activated, the method of FIG. 12, block 1(c) is executed, which will be covered later in detail. If it is determined said set button was not activated, block 5(a) is executed.

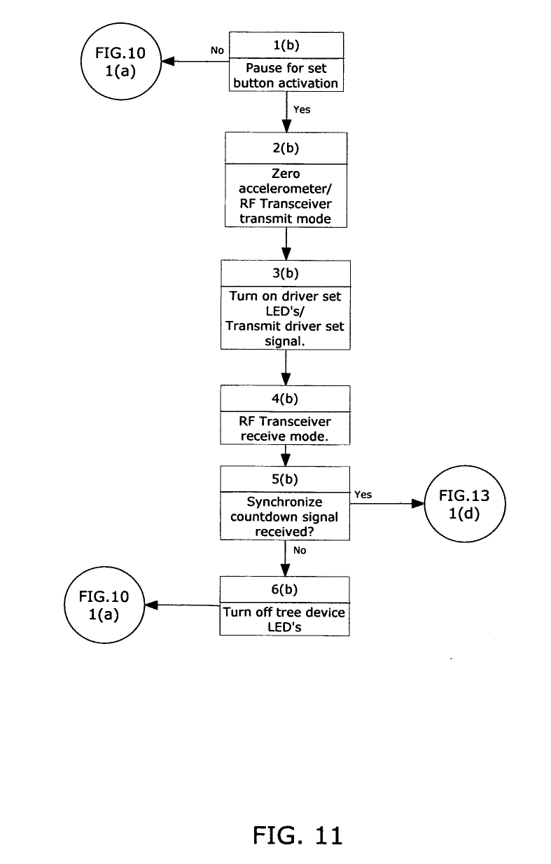

In block (5a), the RF transceiver is checked to see if a driver set signal has been received. If said driver set signal was received, the method path of FIG. 11, block 1(b) is executed which will be covered later in detail.

If said driver set signal has not been received the RF transceiver is switched to transmit mode in block 6(a). Next, in block 7(a) the control unit's ID signal is transmitted while the IDT LED indicator is flashed. Once said ID signal is transmitted, the RF transceiver is switched back to receive mode in block 8(a).

In block 9(a), if said RF transceiver detects another control unit's ID signal the method of block 12(a) is executed illuminating IDR LED indicator. Said RF transceiver remains in receive mode from previous block 8(a) therefore block 1(a) is bypassed and the method path continues back to block 2(a) forming the IDR/IDT cycle.

If, however, at block 9(a) an ID signal is not received, the IDR LED status is checked in block 10(a) to determine if an ID signal was received on a previous IDR/IDT cycle thereby leaving the IDR LED illuminated. If said ID signal was not previously received, the IDR LED would not be illuminated therefore bypassing block 11(a) and continuing to block 2(a). If said IDR LED is on, block 11(a) would be executed in which the IDR LED is turned off. The IDR/IDT cycle continues to loop back to block 2(a). This concludes the method path through the IDR/IDT cycle.

The IDR/IDT cycle is discontinued in one of three possible alternative method paths. One alternate method path occurs at FIG. 10, block 4(a), as previously discussed. If the set button is pressed less than three seconds, the method path of FIG. 12, block 1(c) is executed.

Stage (c) Driver Initiated Race

FIG. 12 is a detailed block diagram illustrating a detailed flowchart of stage (c) of FIG. 9, Driver Initiated Race. Block 1(c) is when the microcontroller takes a voltage reading from the accelerometer and uses this as a base line measurement to compare further accelerometer voltage readings. This is referred to as calibrating the accelerometer's output. During this block, the RF transceiver is switched to transmit mode.

In block 2(c) the driver set LED is illuminated and driver set signal is transmitted.

In block 3(c) the RF transceiver is switched to receive mode.

In block 4(c) is a pause for a pre-determined time is executed allowing for the reception of another control unit's driver set signal. If during the pre-determined time a driver set signal is not received, the method path of FIG. 10, block 1(a) is executed. This restarts the IDR/IDT cycle.

A driver set signal received from a competitor's control unit is interpreted as a competitor set signal therefore in block 5(c) the competitor set LED is illuminated.

Another pause occurs in block 6(c) to allow time for more driver's to press their respectful set buttons and enter the race.

In block 7(c) the RF transceiver is switched to transmit mode. Next, in block 8(c) the RF transceiver transmits the synchronize countdown signal, which leads to method path FIG. 13, block 1(d).

Stage (d) Synchronize Countdown

FIG. 13 is a detailed block diagram illustrating a detailed flowchart of stage (d) of FIG. 9, synchronize countdown. Block 1(d) starts off by enabling the microcontroller to detect a false start from the accelerometer's voltage output by detecting a change in voltage above of below a pre-specified value.

Block 2(d) is when the sequence LED's countdown takes place. As the sequence LED's count down, the following blocks are executed.

During the following blocks, the microcontroller continuously samples voltage readings from the accelerometer output and compares these readings to the reading sampled in FIG. 12, block 1(c).

In block 5(d), the microcontroller determines if a false start has occurred. If a false start has occurred block 8(d) is executed.

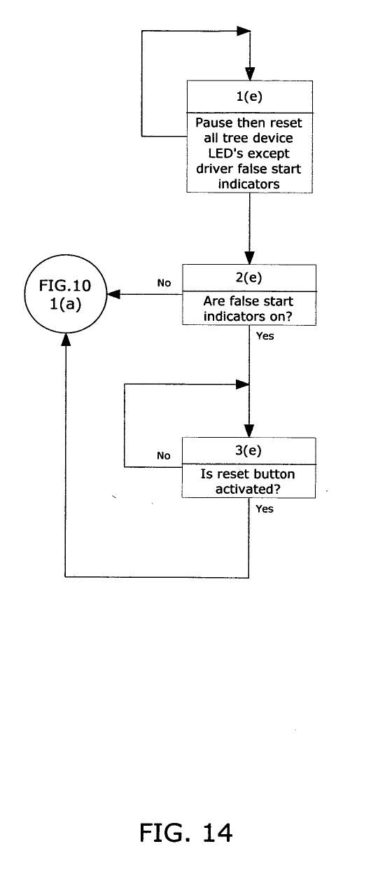

In block 8(d) the microcontroller determines if the VTT bit is set. If said VTT bit is set, the driver false start LED is illuminated, the RF transceiver is left in receive mode and the method path to FIG. 14, block 2(e) is executed. If said VTT bit is not set, then the driver false start LED is illuminated and the RF transceiver is switched to transmit mode.

In block 9(d) the driver false start signal is transmitted. In block 10(d) the RF transceiver is switched to receive mode and follows method path FIG. 14, block 1(e).

Referring to block 5(d), if a driver false start is not detected, block 6(d) is executed.

In block 6(d), the RF transceiver is checked for a driver false start signal from other control units. If no false start signal is received, the method path leads to block 3(d) to determine if the sequence countdown is finished. If a driver false start signal is received, the competitor false start LED is illuminated during block 7(d).

The method path then leads back to block 3(d) to determine if the sequence countdown is finished. Once the sequence countdown is finished, block 4(d) is executed illuminating the start LED. After the start LED is illuminated, the method path continues to FIG. 14, block 1(e).

Stage (e) False Start Memory

FIG. 14 is a detailed block diagram illustrating a detailed flowchart of stage (e) of FIG. 9, False Start Memory. In block 1(e) a pause is created to keep the start LED illuminated for a predetermined period of time. After this pause, all of the LED's on the tree are turned off with the exception of false start indicators.

Within block 2(e) it is determined if the false start indicators are on or off. If no false start indicators are on, the method path continues to FIG. 10, block 1(a) to restart the IDR/IDT cycle. If one or both false start indicators are on, block 3(e) is executed. This block loops back on itself keeping the said false start indicator or indicators illuminated until the reset button is pressed. Once the reset button is activated, the method path continues to FIG. 10, block 1(a) to restart the IDR/IDT cycle.

VTT Cycle

Continuing with another alternate method in which the IDR/IDT cycle is discontinued is the method path of FIG. 10, block 2(a). This method path is similar to the alternate method path of 4(a) discussed previously. The method path starts with block 2(a) where the set button has been pressed for longer than three seconds.

The method path continues to block 3(a) where an internal bit in the microcontroller is set indicating that the VTT cycle is now executing. The microcontroller is then calibrated to the accelerometer's output. The next previously discussed method path is FIG. 13, block 1(d).

Referring to previous discussion, Stage (c) Driver Initiated Race, the method of FIG. 13, block 8(d) checks to see if the VTT bit is set in the microcontroller. If the VTT bit is set, block 8(d) illuminates the driver false start LED and leaves the RF transceiver in receive mode. The method path of FIG. 14, block 2(e) is executed next, which has previously been covered.

Stage (b) Competitor Initiated Race

Continuing with the last alternate method in which the IDR/IDT cycle is discontinued is method path of FIG. 10, block 5(a). The method path of FIG. 11, block 1(b) is selected within block 5(a) if a driver set signal is received. In block 13(a) the competitor set LED's are illuminated following method path to FIG. 11, block 1(b).

FIG. 11 is a detailed block diagram illustrating a detailed flowchart of FIG. 9, stage (b) Competitor Initiated Race. Once the competitor set LED's are on, in block 1(b) the microcontroller checks the set button to see if it is activated within a pre-specified time. If it is not activated within the time allotted, the method path of FIG. 10, block 1(a) is followed. If the button is activated within the allotted time, block 2(b) is executed. The accelerometer's output is calibrated. During this block, the RF transceiver is switched to transmit mode.

In block 3(b) the driver set LED is illuminated and a driver set signal is transmitted. In block 4(b) the transceiver is switched to receive mode. In block 5(b) the RF transceiver is checked if the synchronize countdown signal has been received from the competitor's control unit. If the synchronize start signal is not received, the method path FIG. 10, block 1(a) is executed. If the synchronize start signal is received the method path FIG. 13, block (1d) is executed and is carried out as previously described.

What is claimed is:

1. An in-vehicle Christmas tree for drag race starting and timing system wherein said system has a plurality of power sources, comprising:
a tree device comprising;
two tree identification transmit LED's for indicating transmission of identification signal;
two tree identification receive LED's for indicating identification signal reception;
two driver set LED's for indicating driver status;
two competitor set LED's for indicating competitor status;
three vertical sequence LED's;
a start LED;
a driver false start LED for indicating driver false starts;
a competitor false start LED for indicating competitor false starts;
a radio frequency transceiver antenna;
a control unit comprising;
transceiver means of two way wireless radio frequency communication between said control units;
accelerometer means of detecting a change in vehicle motion and/or acceleration;
microcontroller means of executing methods of said system;
plurality means of power supply;
a remote unit comprising;
a set button;
a reset button.

2. A system of claim 1 means of mounting in or on a vehicle.

3. A system and method of claim 1 means initiating starting and timing a drag race from inside a vehicle.

4. A method of claim 1 means of synchronizing countdown between a plurality of control units, whereby allowing more than two vehicles to race at one time.

5. A method of claim 1 means of two way communication between said control units, whereby driver set LED's and competitor set LED's are utilized on the tree device for direct communication between drivers.

6. A method of claim 1 means for detecting false starts, whereby utilizing an accelerometer integrated circuit to detect a change in vehicle motion and/or acceleration for the detection of false starts regardless of vehicle position and/or state of motion.

7. A method of claim 1 control unit means of transmitting and receiving tree device identification signals to and from a plurality of said control units, whereby allowing the detection of other nearby said control units.

8. A method of claim 1 control unit means of transmitting and receiving false start indication signals to and from a plurality of said control units.

9. A system of claim 1 means of tree device indication using identification receive LED's, whereby indicating other control units are within range.

10. A system of claim 1 means of tree device indication using identification transmit LED's, whereby indicating said control unit is transmitting tree device identification signal.

11. A system of claim 1 plurality means of power supply by onboard replaceable battery or power supplied by vehicle.

12. A system and method of claim 1 starting and timing and start fault detection allowing vehicles to start with predetermined distances between said vehicles

13. A system and method of claim 1 starting and timing and start fault detection allowing vehicles rolling starts.
